(19) United States
(12) Patent Application Publication
(10) Pub. No.: US 2021/0070317 A1
(43) Pub. Date: Mar. 11, 2021

(54) TRAVEL PLAN GENERATION DEVICE, TRAVEL PLAN GENERATION METHOD, AND NON-TRANSITORY TANGIBLE COMPUTER READABLE STORAGE MEDIUM

(71) Applicant: DENSO CORPORATION, Kariya-city (JP)

(72) Inventors: Takafumi HITOTSUMATSU, Kariya-city (JP); Tsuneo NAKATA, Kariya-city (JP)

(21) Appl. No.: 17/100,277

(22) Filed: Nov. 20, 2020

Related U.S. Application Data
(63) Continuation of application No. PCT/JP2019/017325, filed on Apr. 24, 2019.

(30) Foreign Application Priority Data
May 24, 2018 (JP) 2018-099917

(51) Int. Cl. B60W 60/00; H04W 4/024; B60W 10/18; B60W 10/20; B60W 30/14; G01C 21/34

(52) U.S. Cl. CPC B60W 60/001; H04W 4/024; B60W 10/18; B60W 2520/06; B60W 30/143; G01C 21/3453; B60W 2555/20; B60W 10/20

(57) ABSTRACT

A travel plan generation device generates a travel plan including a recommended route for a travel of a driving support vehicle. The drive support vehicle is a vehicle that (i) performs a driving support for the vehicle by performing a positioning to identify a position of the vehicle using an autonomous sensor attached to the vehicle and (ii) performs the driving support based on information obtained by a communication resource. The travel plan generation device stores a communication resource map indicating a correspondence relationship between a point and a communication resource amount that is an amount of the communication resource estimated to be available for communication at the point. The travel plan generation device stores a positioning accuracy map indicating a correspondence relationship between a point and a positioning accuracy estimated when the autonomous sensor performs the positioning of the vehicle at the point.

### CROSS REFERENCE TO RELATED APPLICATIONS

The present application is a continuation application of International Patent Application No. PCT/JP2019/017325 filed on Apr. 24, 2019, which designated the U.S. and claims the benefit of priority from Japanese Patent Application No. 2018-099917 filed on May 24, 2018. The entire disclosures of all of the above applications are incorporated herein by reference.

### TECHNICAL FIELD

The present disclosure relates to a travel plan generation device, a travel plan generation method, and a non-transitory tangible computer readable storage medium for generating a travel plan of a vehicle.

### BACKGROUND

A technique that suppresses shortage of wireless resources in a planned travel route for a vehicle has been proposed. As an example technique, a management server may predict a time zone in which a vehicle passes through a service provision area of a base station based on a request for wireless resource allocation transmitted from the vehicle. The management server may reserve the wireless resource of the base station for the vehicle in the predicted time zone. When the required wireless resource cannot be reserved, the management server may search for an alternative route capable of reserving the requested resource amount and present the alternative route to the vehicle.

### SUMMARY

The present disclosure provides a travel plan generation device. A travel plan generation device generates a travel plan including a recommended route for a travel of a driving support vehicle. The drive support vehicle is a vehicle that (i) performs a driving support for the vehicle by performing a positioning to identify a position of the vehicle using an autonomous sensor attached to the vehicle and (ii) performs the driving support based on information obtained by a communication resource. The travel plan generation device stores a communication resource map indicating a correspondence relationship between a point and a communication resource amount that is an amount of the communication resource estimated to be available for communication at the point. The travel plan generation device stores a positioning accuracy map indicating a correspondence relationship between a point and a positioning accuracy estimated when the autonomous sensor performs the positioning of the vehicle at the point.

### BRIEF DESCRIPTION OF DRAWINGS

The features and advantages of the present disclosure will become more apparent from the following detailed description made with reference to the accompanying drawings. In the drawings:

FIG. 1 is a diagram showing an example of a schematic configuration of a travel plan generation system;

FIG. 2 is a drawing showing an example of a schematic configuration of a map distribution center;

FIG. 3 is a diagram showing an example of a communication resource map;

FIG. 4 is a diagram that visualizes an example of the communication resource map;

FIG. 5 is a diagram showing an example of a positioning accuracy map;

FIG. 6 is a diagram that visualizes an example of the positioning accuracy map;

FIG. 7 is a diagram showing an example of a schematic configuration of a vehicle-side unit;

FIG. 8 is a diagram showing an example of a schematic configuration of an automatic driving ECU;

FIG. 9 is a diagram showing an example of a schematic configuration of a medium to long term plan unit;

FIG. 10 is a diagram showing an example of a positioning accuracy satisfaction region;

FIG. 11 is a schematic diagram showing an example of extracting a communication resource amount satisfaction region from the communication resource amount map selected by a map selection unit;

FIG. 12 is a schematic diagram showing an example of generating a selectable map from the positioning accuracy satisfaction region and the communication resource amount satisfaction region;

FIG. 13 is a schematic diagram showing an example of searching for a recommended route from a candidate route and a selectable map; and

FIG. 14 is a flowchart showing an example of a flow of recommended route determination related processing in the medium to long term plan unit.

### DETAILED DESCRIPTION

For a vehicle (hereinafter referred to as a driving support vehicle) that performs driving support, such as automatic driving of a subject vehicle, by identifying a position of the subject vehicle using an autonomous sensor mounted on the subject vehicle, a situation where sufficient positioning accuracy cannot be acquired from the autonomous sensor may occur. In order to avoid this situation, it is considered that information acquired using a wireless resource is employed for a positioning of the subject vehicle.

The situation where the sufficient positioning accuracy cannot be acquired from the autonomous sensor of the driving support vehicle does not always occur. Thus, a region in which requirement for wireless resource is high and a region in which requirement for wireless resource is low exist. As in the example technique, when a management server searches for a route capable of securing a wireless resource over the entire planned route, the search for an alternative route may be repeated many times and the alternative route may take a detour more than necessary.

The present disclosure provide a travel plan generation device, a travel plan generation method, and a non-transitory tangible computer readable storage medium each of which suppresses a waste for generating a travel plan of a driving support vehicle that perform positioning using information acquired by a communication resource.

An exemplary embodiment of the present disclosure provides a travel plan generation device. A travel plan generation device includes a travel plan generation unit, a communication resource map storage unit, a positioning accuracy map storage unit, and a request identification unit. The travel plan generation unit generates a travel plan including a recommended route for a travel of a driving support vehicle. The drive support vehicle is a vehicle configured to (i) perform a driving support for the vehicle by performing a positioning to identify a position of the vehicle using an autonomous sensor attached to the vehicle and (ii) perform the driving support based on information obtained by a communication resource. The communication resource map storage unit stores a communication resource map indicating a correspondence relationship between a point and a communication resource amount that is an amount of the communication resource estimated to be available for communication at the point. The positioning accuracy map storage unit stores a positioning accuracy map indicating a correspondence relationship between a point and a positioning accuracy estimated when the autonomous sensor performs the positioning of the vehicle at the point. The request identification unit identifies a required communication resource amount that is a communication resource amount required for executing an application including at least the driving support for the driving support vehicle. The travel plan generation unit selects, as a candidate for the recommended route, a point having a value of the positioning accuracy in the positioning accuracy map equal to or greater than a threshold value even when the communication resource amount in the communication resource map does not satisfy the required communication resource amount at the point. The travel plan generation unit selects, as the candidate for the recommended route, a point having the communication resource amount in the communication resource map which satisfies the required communication resource amount even when the value of the positioning accuracy in the positioning accuracy map is less than the threshold value at the point.

Another exemplary embodiment of the present disclosure provides a travel plan generation method. The travel plan generation method includes: generating a travel plan including a recommended route for a travel of a driving support vehicle, the drive support vehicle being a vehicle configured to (i) perform a driving support for the vehicle by performing a positioning to identify a position of the vehicle using an autonomous sensor attached to the vehicle and (ii) perform the driving support based on information obtained by a communication resource; storing a communication resource map indicating a correspondence relationship between a point and a communication resource amount that is an amount of the communication resource estimated to be available for communication at the point; storing a positioning accuracy map indicating a correspondence relationship between a point and a positioning accuracy estimated when the autonomous sensor performs the positioning of the vehicle at the point; and identifying a required communication resource amount that is a communication resource amount required for executing an application including at least the driving support for the driving support vehicle. The generating of the travel plan includes selecting, as a candidate for the recommended route, a point having a value of the positioning accuracy in the positioning accuracy map equal to or greater than a threshold value even when the communication resource amount in the communication resource map does not satisfy the required communication resource amount at the point. The generating of the travel plan includes selecting, as the candidate for the recommended route, a point having the communication resource amount in the communication resource map which satisfies the required communication resource amount even when the value of the positioning accuracy in the positioning accuracy map is less than the threshold value at the point.

Another exemplary embodiment of the present disclosure provides a non-transitory tangible computer readable storage medium. The non-transitory tangible computer readable storage medium includes instructions executed by a processor of a travel plan generation device. The instructions includes generating a travel plan including a recommended route for a travel of a driving support vehicle, the drive support vehicle being a vehicle configured to (i) perform a driving support for the vehicle by performing a positioning to identify a position of the vehicle using an autonomous sensor attached to the vehicle and (ii) perform the driving support based on information obtained by a communication resource; storing a communication resource map indicating a correspondence relationship between a point and a communication resource amount that is an amount of the communication resource estimated to be available for communication at the point; storing a positioning accuracy map indicating a correspondence relationship between a point and a positioning accuracy estimated when the autonomous sensor performs the positioning of the vehicle at the point; and identifying a required communication resource amount that is a communication resource amount required for executing an application including at least the driving support for the driving support vehicle. The generating of the travel plan includes selecting, as a candidate for the recommended route, a point having a value of the positioning accuracy in the positioning accuracy map equal to or greater than a threshold value even when the communication resource amount in the communication resource map does not satisfy the required communication resource amount at the point. The generating of the travel plan includes selecting, as the candidate for the recommended route, a point having the communication resource amount in the communication resource map which satisfies the required communication resource amount even when the value of the positioning accuracy in the positioning accuracy map is less than the threshold value at the point.

In the exemplary embodiment of the present disclosure, even in a point having the communication resource amount, in the communication resource map, which does not satisfy the required communication resource amount, when the point has the value of positioning accuracy in the positioning accuracy map equal to or greater than the threshold value, the point can be the candidate for the recommended route and the traveling plan including the recommended route can be generated. Thus, the recommended route is not searched so that the required communication resource amount is secured over the entire route. Accordingly, it is possible to reduce a waste for generating the travel plan.

Even in a point having the value of the positioning accuracy in the positioning accuracy map less than the threshold value, the point that satisfies the required communication resource amount can be the candidate for the recommended route and the traveling plan including the recommended route can be generated. The drive support vehicle is a vehicle that performs a driving support for the vehicle by performing a positioning to identify a position of the vehicle using an autonomous sensor attached to the vehicle and performs the driving support based on information obtained by a communication resource. Therefore, the configuration can generate a recommended route in which the driving support vehicle can reliably receive the driving support by the information acquired by using the communication resource. As a result, the configuration can suppress waste in generating a travel plan for the driving support vehicle that uses the information acquired using the communication resource for the positioning of the subject vehicle.

Multiple embodiments will be described for disclosure hereinafter with reference to the drawings. For convenience of description, the same reference numerals are assigned to portions having the same functions as those shown in the drawings used in the description so far among the plurality of embodiments, and a description of the same portions may be omitted. Description in another applicable embodiment may be referred to for such a portion denoted by the identical reference sign.

(First Embodiment)

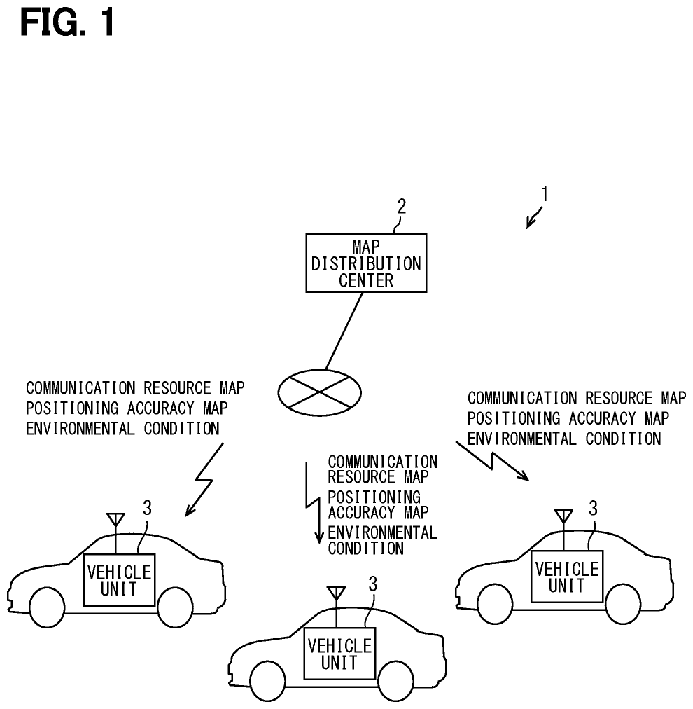

(Travel Plan Generation System 1) The first embodiment of the present disclosure is described with reference to the drawings. As shown in FIG. 1, a travel plan generation system 1 includes a map distribution center 2 and a vehicle-side unit 3 used in a driving support vehicle that supports driving of a vehicle.

The driving support vehicle supports driving of the subject vehicle by identifying the position of the subject vehicle using an in-vehicle autonomous sensor. The driving support vehicle also supports driving of the subject vehicle based on information acquired using a communication resource.

The autonomous sensor may be provided by a GNSS receiver and a peripheral monitor sensor 32, which will be described later. The driving support may include automatic driving that can be divided into automatic driving level sections (hereinafter, simply referred to as automatic driving levels) of six stages of 0 to 5 defined by SAE International. The communication resource may include wide area communication that is communication between a vehicle and the center via a public communication network, vehicle-to-vehicle communication that is direct wireless communication between vehicles, or road-to-vehicle communication that is direct wireless communication between the vehicle and a roadside device. The wide area communication may include communication in accordance with 3G standard, communication in accordance with LTE (Long Term Evolution) standard, communication in accordance with 5G standard, or communication in accordance with Wi-Fi standard. Wi-Fi is a registered trademark. The vehicle-to-vehicle communication may include communication using 760 MHz band, communication using 2.4 GHz band, communication using 5.9 GHz band, or communication in accordance with WAVE (Wireless Access in Vehicular Environment) standard. The road-to-vehicle communication may include communication using 2.4 GHz band, or communication using the 5.9 GHz band. The following description will be given with an example of using a vehicle capable of performing automatic driving of the automatic driving level “4” or higher as the driving support vehicle.

(Map Distribution Center 2)

The map distribution center 2 may be provided by a server device installed outside the driving support vehicle. The map distribution center 2 is provided with a large-capacity storage device such as a hard disk drive. The map distribution center 2 is connected to a public communication network and communicates with the vehicle-side unit 3 used in each of the driving support vehicles. The map distribution center 2 may be provided by one server device, or a plurality of server devices. The map distribution center 2 may be provided with a distributed network such as a cloud or a block chain.

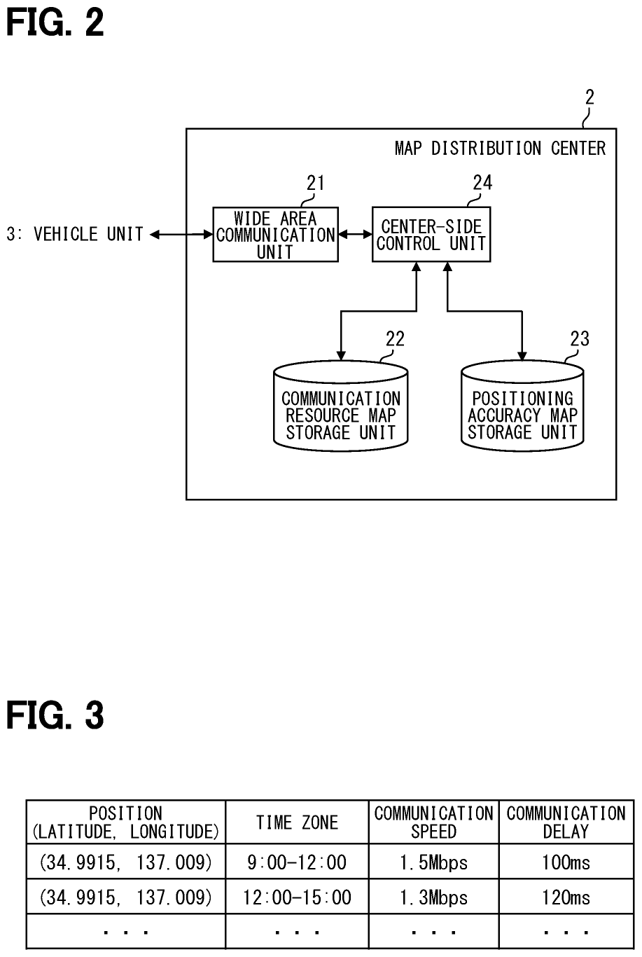

Here, an example of the schematic configuration of the map distribution center 2 will be described with reference to FIG. 2. The map distribution center 2 includes a wide area communication unit 21, a communication resource map storage unit 22, a positioning accuracy map storage unit 23, and a center-side control unit 24.

The wide area communication unit 21 communicates with the vehicle-side unit 3 via the public communication network. The wide area communication unit 21 inputs the information received from the vehicle-side unit 3 to the center-side control unit 24, and transmits the information output from the center side control unit 24 to the vehicle-side unit 3. The information received from the vehicle-side unit 3 by the wide area communication unit 21 may include request information for requesting a communication resource map described later, or request information for requesting a positioning accuracy map described later. The request information may include identification information for identifying the vehicle-side unit 3 from which the request information is transmitted, or information for identifying the range for requesting the map (hereinafter, range identification information). In the following, the description will be given with an example of using a vehicle ID as the identification information.

The communication resource map storage unit 22 stores a communication resource map indicating a correspondence relationship between a point and an amount of communication resources estimated to be available for communication at the point. The point may be provided by position information. The amount of communication resources may be indicated by communication speed, communication delay. Hereinafter, the amount of communication resources will be indicated by a combination of communication speed and communication delay. The amount of communication resources may be usable capacity, width of usable communication band. As the communication speed, for example, an amount of data that can be transferred per second in upload (that is, uplink communication) and download (that is, downlink communication) may be used. As the delay time, for example, time of communication delay in upload (that is, uplink communication) and download (that is, downlink communication) may be used. It is assumed that the amount of communication resources increases when the communication speed increases or the communication delay decreases, and the amount of communication resources decreases when the communication speed decreases or the communication delay increases.

The communication resource map is stored in the communication resource map storage unit 22 for each time zone. The time zone may be provided by being equally divided such as every three hours, or may be provided by being unequally divided such as shortening or lengthening a specific time zone. Further, in order to reduce the communication load at the time of distribution, the communication resource map may be stored in the communication resource map storage unit 22 for each of multiple regions. The communication resource may be provided by the vehicle-to-vehicle communication and the road-to-vehicle communication. In this case, the communication resource amount may be provided by the estimated number of vehicles capable of vehicle-to-vehicle communication or the number of roadside devices.

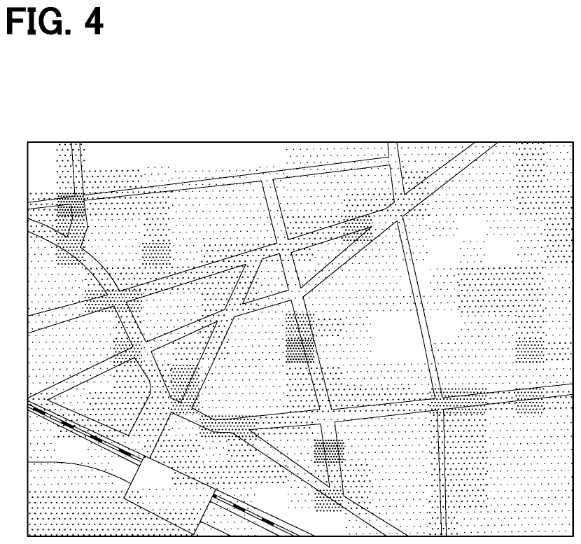

Here, an example of the communication resource map is shown with reference to FIGS. 3 and 4. As shown in FIG. 3, the communication resource map may be a table indicating the correspondence relationship of the position coordinates, the time zone, the communication speed, and the communication delay. The communication resource map is not limited to the table shown in FIG. 3. The communication resource map may include a communication carrier or a communication method. Further, the parameters of the communication resource map may be continuous values or the communication resource map may be represented by distribution. Positional coordinates (that is, point) are assumed to be a point that represents a certain region. The region referred to here may be a unit such as a rectangular region defined by a grid pattern on a map such as a mesh, or a unit such as a link or a node. In the following, the description will be given with the region having a rectangular shape defined by a grid pattern on a map.

As an example, in the communication resource map, the communication resource amount represented by a combination of communication speed and communication delay is set for each rectangular region defined in a grid pattern on the map. Here, an example in a case of visualizing the communication resource map will be described with reference to FIG. 4. When the communication resource map is visualized, the shading of each region indicates the amount of communication resources. Each region in the communication resource map is shown darker as the amount of communication resources is larger, and shown lighter as the amount of communication resources is smaller.

The positioning accuracy map storage unit 23 stores a positioning accuracy map. The positioning accuracy map indicates a correspondence relationship between a point and the positioning accuracy estimated when the autonomous sensor of the driving support vehicle performs positioning of the subject vehicle at the point. The point may be location information similar to the communication resource map. The positioning accuracy may be indicated by an error of the positioning result, reliability of the positioning. In the following, as an example, the positioning accuracy is indicated by a combination of the error and the reliability. As the error, for example, the amount of deviation of the positioning result may be used. As the reliability, for example, availability, which is the probability that the positioning accuracy required for the navigation system is realized, may be used. The positioning accuracy is high when the error is small and the reliability is high. The positioning accuracy is low when the error is high and the reliability is low.

The positioning accuracy map may be stored in the positioning accuracy map storage unit 23 for the types of autonomous sensors used for positioning, or stored in the positioning accuracy map storage unit 23 without being divided for the types of autonomous sensor used for positioning. When the positioning accuracy map is stored in the positioning accuracy map storage unit 23 without being divided for the types of autonomous sensors used for positioning, the positioning accuracy obtained by comprehensively evaluating the multiple autonomous sensors used for positioning is associated with the point.

When the peripheral monitor camera described later is used for positioning as an autonomous sensor, the time zone, backlight, and weather affect the positioning accuracy. When the millimeter wave radar or LIDAR described later is used for positioning, the weather affects the positioning accuracy. When the GNSS receiver described later is used for positioning, the satellite arrangement of the positioning satellite affects the positioning accuracy. Therefore, the positioning accuracy map may be stored in the positioning accuracy map storage unit 23 for each environmental condition such as the time zone, the weather information, the traveling direction, and the satellite arrangement. The time zone referred to here may be divided equally or unequally. Further, in order to reduce the communication load at the time of distribution, the positioning accuracy map may be stored in the positioning accuracy map storage unit 23 for each of the multiple regions.

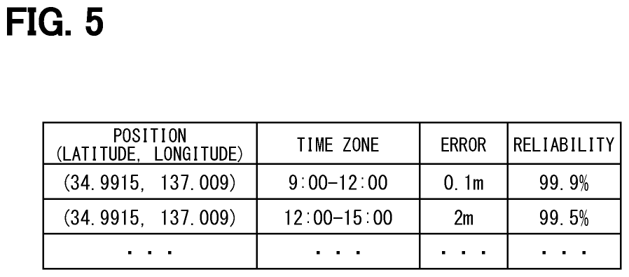

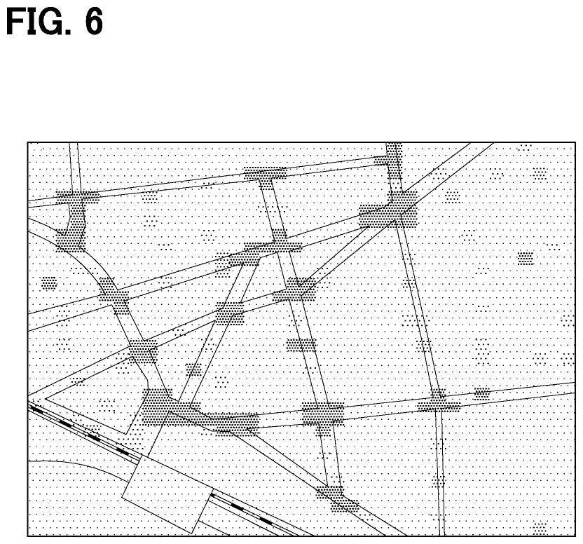

Here, an example of the positioning accuracy map is shown with reference to FIGS. 5 and 6. As shown in FIG. 5, the positioning accuracy map may be a table indicating the correspondence relationship among the position coordinates, the time zone, the error, and the reliability. The positioning accuracy map is not limited to the example shown in FIG. 5. As described above, the positioning accuracy map may be divided by each environmental condition except for the time zone such as the weather information, the satellite arrangement, or the traveling direction. Further, the parameters of the positioning accuracy map may be represented by a distribution. The position coordinates (that is, point) are assumed to be a point that represents a certain region as described in the communication resource map. In the following, the description will be given with the region having a rectangular shape defined by a grid pattern on a map. In the positioning accuracy map for each environment, the positioning accuracy may be lower as the environmental condition deteriorates the positioning accuracy. The example of environmental condition that deteriorate positioning accuracy include rain, snow, fog, or the like in the weather information, the direction of travel that is backlight, the time zone that corresponds to nighttime, or the satellite arrangement having PDOP (Position DOP) above a certain value.

As an example, in the positioning accuracy map, the positioning accuracy represented by a combination of the error and the reliability is set for each rectangular region defined in a grid pattern on the map. Here, an example in a case of visualizing the positioning accuracy map will be described with reference to FIG. 6. When the positioning accuracy map is visualized, the shading of each region indicates the level of positioning accuracy. Each region in this positioning accuracy map is shown darker as the positioning accuracy is higher, and is shown lighter as the positioning accuracy is lower. Since the type of the autonomous sensor mounted on a vehicle may differ depending on a vehicle type, the positioning accuracy map may be stored in the positioning accuracy map storage unit 23 for each vehicle type. It is preferable that the units of the regions of the communication resource map and the positioning accuracy map are aligned.

The center-side control unit 24 is provided by an electronic control device configured by a microcomputer as a main body that includes a processor, a memory, an I/O, and buses connecting these, and performs various processes by executing control programs stored in the memory. Execution of this control program by the processor corresponds to execution of a method corresponding to the control program. The memory is a non-transitory tangible storage medium for non-transitory storage of computer readable programs and data. The non-transitory tangible storage medium is embodied by a semiconductor memory or a magnetic disk.

The center-side control unit 24 selects a communication resource map and a positioning accuracy map according to the request information received from the vehicle-side unit 3 via the wide area communication unit 21. The center-side control unit 24 causes the wide area communication unit 21 to distribute the selected communication resource map and the selected positioning accuracy map. The details are described as follows.

The center-side control unit 24 identifies the range of the map required by the request information from the range identification information included in the request information received by the wide area communication unit 21. Then, the center-side control unit 24 selects a map corresponding to the identified range from the communication resource map and the positioning accuracy map stored for each region, and causes the wide area communication unit 21 to distribute the selected map. The range identification information may be position information of the departure point and the destination for the driving support vehicle, a mesh code of the map, a coordinate group indicating the range, or the like. When the range identification information is the position information of the departure point and the destination for the driving support vehicle, the map corresponding to the region that includes the route from the departure point to the destination may be selected. When the range identification information is the mesh code for the map, the map corresponding to this mesh code may be selected. When the range identification information is a coordinate group indicating a range, a map corresponding to this range may be selected. In the following, a case where the range identification information is a mesh code will be described as an example.

When the positioning accuracy map storage unit 23 stores the positioning accuracy map for each type of the autonomous sensor or vehicle type, the center-side control unit 24 causes the wide area communication unit 21 to distribute the positioning accuracy map according to the type of autonomous sensor mounted on the driving support vehicle or the vehicle type of the vehicle. In this case, the request information may include the vehicle type information of the driving support vehicle or the type information of the autonomous sensor mounted on the driving support vehicle. When the center-side control unit 24 may use the information on the correspondence relationship between the vehicle type and the vehicle ID, the vehicle type may be identified from the vehicle ID included in the request information and the information on the correspondence. When the center-side control unit 24 may use the information on the correspondence between the vehicle type and the type of the mounted autonomous sensor, the type of the mounted autonomous sensor is identified from the information on the vehicle type and the correspondence.

Further, the center-side control unit 24 causes the wide area communication unit 21 to distribute the environmental condition regarding the range of the map identified from the range identification information included in the request information received by the wide area communication unit 21 to the vehicle-side unit 3 that has transmitted the request information. The environmental condition distributed from the wide area communication unit 21 may be provided by weather information or satellite arrangement. The information on the environmental condition to be distributed from the wide area communication unit 21 may be information for each time zone in the future for a certain period or longer so that the environmental condition in the future can be identified by the vehicle-side unit 3.

(Vehicle-Side Unit 3)

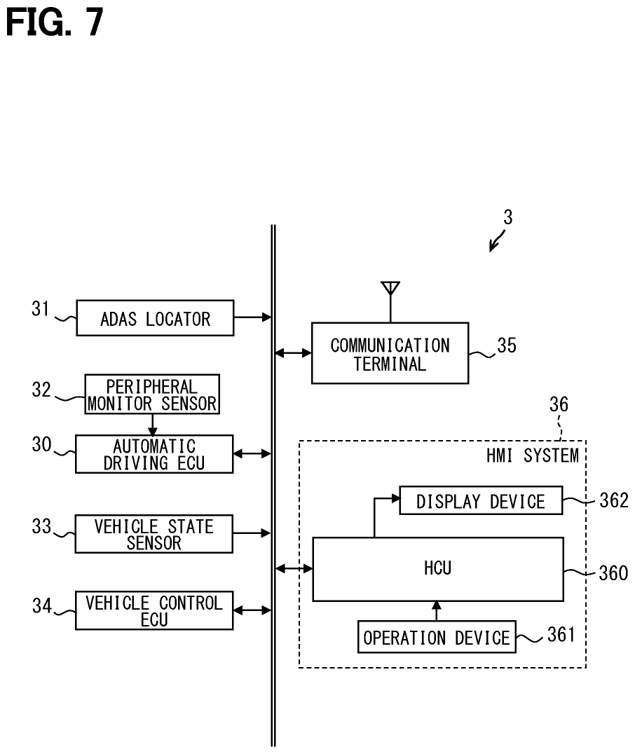

An example of a schematic configuration of the vehicle-side unit 3 will be next described with reference to FIG. 7. The vehicle-side unit 3 includes, as shown in FIG. 7, an automatic driving ECU 30, an ADAS (Advanced Driver

Assistance Systems) locator 31, a peripheral monitor sensor 32, a vehicle state sensor 33, a vehicle control ECU 34, a communication terminal 35, and an HMI (Human Machine Interface) system 36. The automatic driving ECU 30, the ADAS locator 31, the peripheral monitor sensor 32, the vehicle state sensor 33, the vehicle control ECU 34, the communication terminal 35, and the HMI system 36 may be connected to an in-vehicle LAN.

The ADAS locator 31 includes a GNSS (Global Navigation Satellite System) receiver, an inertial sensor, and a map database (hereinafter, DB) storing map data. The GNSS receiver receives positioning signals from multiple positioning satellites. The inertial sensor includes a gyro sensor and an acceleration sensor, for example. The map DB is a nonvolatile memory, and stores map data such as link data, node data, road shape, or the like. The map data may include a three-dimensional map including road shapes and features of structures represented by dots.

The ADAS locator 31 sequentially measures a position of a subject vehicle by combining the positioning signal received by the GNSS receiver and the measurement result of the inertial sensor. Alternatively, the vehicle position may be measured based on a traveling distance obtained from detection results sequentially output from a vehicle speed sensor mounted on the subject vehicle. Then, the measured vehicle position is output to the in-vehicle LAN. In case of using a three-dimensional map that includes a point group of road shapes and feature points of road-related structure as the map data, the ADAS locator 31 does not use the GNSS receiver, but uses the three-dimensional map and detection results of the peripheral monitor sensor 32 such as LIDAR (Light Detection and Ranging/Laser Imaging Detection and Ranging) for detecting a point group of road shapes and feature points of road-related structures to identify the position of the subject vehicle. Note that the map data may be acquired from outside of the subject vehicle via the communication terminal 35.

The peripheral monitor sensor 32 is an autonomous sensor that monitors the surrounding environment of the subject vehicle. For example, the peripheral monitor sensor 32 detects an obstacle around the subject vehicle, such as a pedestrian, a moving object like another vehicle, or stationary object such as an object on the road. The peripheral monitor sensor 4 also detects road surface markings such as a traffic lane marking around the subject vehicle. The peripheral monitor sensor 32 is, for example, a sensor such as a peripheral monitor camera that captures a predetermined range around the subject vehicle, a millimeter wave radar that transmits a search wave to a predetermined range around the subject vehicle, a sonar, or a LIDAR. The peripheral monitor camera sequentially outputs a captured image to the automatic driving ECU 30 as sensing information. A sensor that transmits a probe wave such as a sonar, a millimeter wave radar, a LIDAR or the like sequentially outputs, as the sensing information to the automatic driving ECU 30, a scanning result based on a received signal acquired as a reflected wave by an obstacle on the road.

The vehicle state sensor 33 is a sensor group for detecting various states of the subject vehicle. The vehicle state sensor 33 includes a vehicle speed sensor that detects the vehicle speed of the subject vehicle, a steering sensor that detects the steering angle of the subject vehicle, an accelerator position sensor that detects the opening degree of the accelerator pedal of the subject vehicle, and a brake pedal force sensor that detects the amount of depression of the brake pedal of the subject vehicle. The vehicle state sensor 33 outputs the detected sensing information to the in-vehicle LAN. The sensing information detected by the vehicle state sensor 33 may be output to the in-vehicle LAN via the ECU mounted on the subject vehicle.

The vehicle control ECU 34 is an electronic control device that performs acceleration/deceleration control or steering control of the subject vehicle. The vehicle control ECU 34 includes a steering ECU that performs steering control, a power unit control ECU that performs acceleration/deceleration control, a brake ECU, or the like. The vehicle control ECU 34 acquires detection signals output from respective sensors such as the accelerator position sensor, the brake pedal force sensor, the steering angle sensor, the vehicle speed sensor mounted on the subject vehicle, and outputs a control signal to an electronic control throttle, a brake actuator, an EPS (Electronic Power Steering) motor, and the like. Further, the vehicle control ECU 34 is capable of outputting the sensing information of each of the above sensors to the in-vehicle LAN.

The communication terminal 35 performs the wide area communication with a center such as the map distribution center 2 via the public communication network by performing transmission and reception of information by wireless communication with an access point of the wireless LAN. Further, the communication terminal 35 performs the above-mentioned vehicle-to-vehicle communication that directly performs wireless communication with another vehicle, or performs the above-mentioned road-to-vehicle communication that directly performs wireless communication with the roadside device. The communication terminal 35 may indirectly communicate with another vehicle via the center by wide area communication.

The communication terminal 35 transmits the request information for requesting the communication resource map or the request information for requesting the positioning accuracy map to the map distribution center 2. The communication terminal 35 receives, based on the request information, the information on the communication resource map, the positioning accuracy map, or the environmental condition transmitted from the map distribution center 2. The communication terminal 35 may receive positioning usage information distributed from the center that distributes information capable of being used for identifying the position of the subject vehicle. The positioning usage information distributed from the center may include information for positioning reinforcement such as atmospheric delay correction value for improving the accuracy of positioning using the GNSS receiver, or dynamic map information sequentially generated from the probe information of the multiple vehicles by the center.

In addition, the communication terminal 35 receives the positioning usage information transmitted from another vehicle via vehicle-to-vehicle communication. The positioning usage information transmitted from another vehicle may include position information of another vehicle, or position information of the obstacle detected by an autonomous sensor mounted on another vehicle. The communication terminal 35 may indirectly receive, from a first other vehicle, the positioning usage information of a second other vehicle which is acquired by the first other vehicle via the vehicle-to-vehicle communication with the second other vehicle. In addition, the communication terminal 35 receives the positioning usage information transmitted from the roadside device via road-to-vehicle communication. The positioning usage information transmitted from the roadside device includes the position information of the obstacle detected by the sensor of the roadside device. The communication terminal 35 may indirectly receive, from the roadside device, the positioning usage information of another vehicle which is acquired by the roadside device via the road-to-vehicle communication with another vehicle. In the travel plan generation system 1, the communication terminal 35 used in each of the multiple vehicles may have different available communication resources.

As shown in FIG. 7, the HMI system 36 includes an HCU (Human Machine Interface Control Unit) 360, an operation device 361, and a display device 362. The HMI system 36 receives input operation from a driver of the subject vehicle and presents information to the driver.

The operation device 361 is a switch group operated by the driver of the subject vehicle. The operation device 361 is used to perform various settings. The operation device 361 may include a steering switch provided to a spoke portion of the subject vehicle's steering, a touch switch integral with the display device 362, or the like. The display device 362 may include a combination meter, a CID (Center Information Display), a navigation device, or the like. The display device 362 displays various images for presenting information based on the image data obtained from the HCU 360 on a display screen.

The HCU 360 includes a processor, a memory, an I/O, and a bus connecting these, and executes various processes by the CPU executing a control program stored in the memory. For example, the HCU 360 outputs, to the automatic driving ECU 30, the setting information for the departure point and the destination received by the operation input from the driver by the operation device 361, or causes the display device 362 to present the information according to the instruction from the automatic driving ECU 30.

The automatic driving ECU 30 includes a processor, a memory, an I/O, and a bus that connects those devices, and executes various processes related to the automatic driving by executing a control program stored in the memory. Execution of this control program by the processor corresponds to execution of a method corresponding to the control program. The memory referred to herein is a non-transitory tangible storage medium configured to non-temporarily store a program and data readable by a computer. The non-transitory tangible storage medium is embodied by a semiconductor memory or a magnetic disk.

(Automatic Driving ECU 30)

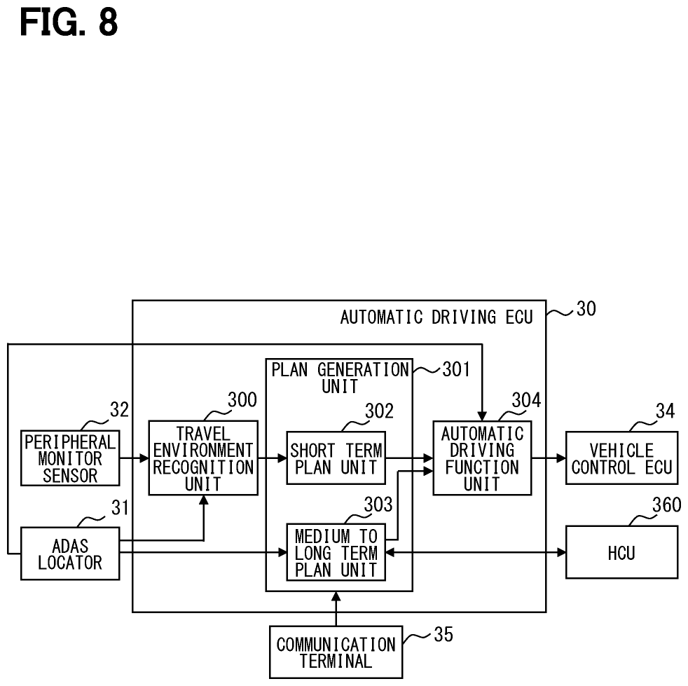

Subsequently, a schematic configuration of the automatic driving ECU 30 will be described with reference to FIG. 8. As shown in FIG. 8, the automatic driving ECU 30 includes a travel environment recognition unit 300, a plan generation unit 301, and an automatic driving function unit 304 as functional blocks. In addition, a part or all of the functions executed by the automatic driving ECU 30 may be configured in hardware with one or more ICs or the like. Alternatively, some or all of the functional blocks of the automatic driving ECU 30 may be implemented by a combination of software executed by a processor and hardware.

The travel environment recognition unit 300 recognizes the travel environment of the subject vehicle from the position of the subject vehicle obtained by the ADAS locator 31, the map data, sensing information acquired by the peripheral monitor sensor 32, and the like. In recognizing the travel environment of the subject vehicle, the position of the subject vehicle with respect to the obstacle and the lane marking line, such as the relative position between the subject vehicle and the obstacle and the relative position between the subject vehicle and the lane marking line, is also identified. Therefore, the positioning for identifying the position of the subject vehicle is not limited to the positioning for identifying the vehicle position with the ADAS locator 31, but also the positioning for identifying the position of the subject vehicle with respect to the obstacle or the traveling lane.

The travel environment recognition unit 300 may recognize a position, a shape, and a moving state of an object around the subject vehicle from the sensing information acquired from the peripheral monitor sensor 32 within the sensing range of the peripheral monitor sensor 32, and create a virtual space that reproduces the actual driving environment. In addition, the travel environment recognition unit 300 recognizes the travel environment outside the sensing range of the peripheral monitor sensor 32 by using information such as map data.

Further, the travel environment recognition unit 300 is capable of recognizing the travel environment of the subject vehicle from the positioning usage information received by the communication terminal 35, and reinforcing the recognition of the travel environment by the autonomous sensor. The travel environment recognition unit 300 is capable of recognizing the travel environment of the subject vehicle from the information acquired by using the communication resource.

The plan generation unit 301 includes a short term plan unit 302 and a medium to long term plan unit 303. The plan generation unit 301 generates a travel plan for driving the subject vehicle by automatic driving. The short term plan unit 302 generates a short term travel plan, and the medium to long term plan unit 303 generates a medium to long term travel plan. The travel plan generated by the plan generation unit 301 is output to the automatic driving function unit 304.

The medium to long term plan unit 303 generates, as the travel plan of the medium to long term, a recommended route for directing the subject vehicle to the destination and a planned vehicle speed for traveling on the recommended route. The recommended route extends beyond the sensing range of the peripheral monitor sensor 32. The processes performed by the medium to long term plan unit 303 will be described later in more detail.

The short term plan unit 302 generates a driving plan for short term using the travel environment recognized by the travel environment recognition unit 300 in order to travel according to the recommended route and the planned vehicle speed generated by the medium to long term plan unit 303. As a specific example, the short term plan unit 302 determines steering for changing lanes, acceleration/deceleration for speed adjustment, steering braking for avoiding obstacles, and the like. Traveling according to the planned vehicle speed is not limited to maintaining the planned vehicle speed, but also accelerating/decelerating, which deviates from the planned vehicle speed, as necessary with reference to the planned vehicle speed.

The automatic driving function unit 304 causes the vehicle control ECU 34 to automatically accelerate, brake, or steer the subject vehicle according to the travel plan output from the plan generation unit 301, thereby replacing the driving operation of the driver. The replacement of the driving operation is referred to as automatic driving.

(Medium to Long Term Plan Unit 303)

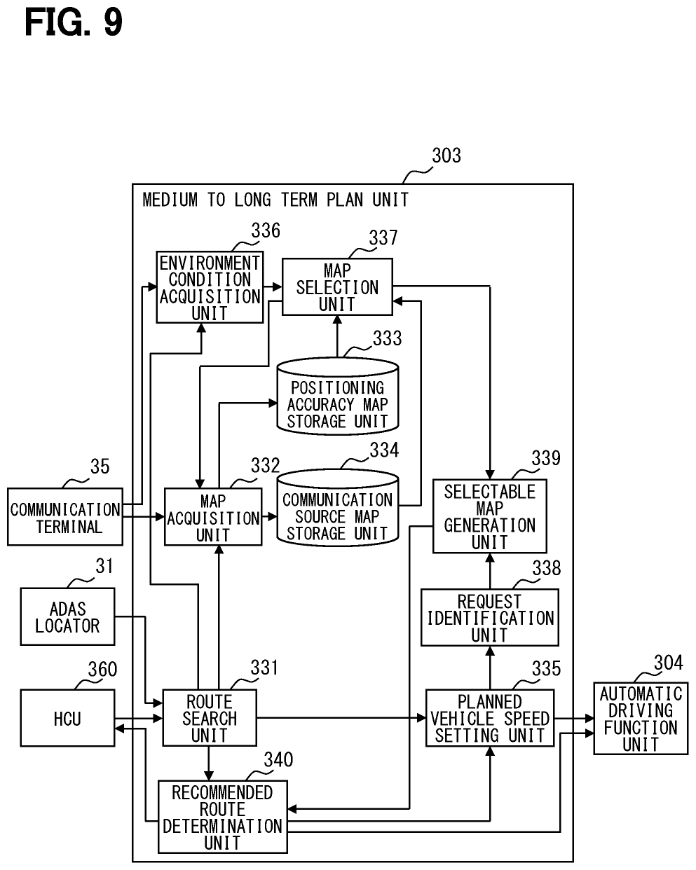

Subsequently, a schematic configuration of the medium to long term plan unit 303 will be described with reference to FIG. 9. As shown in FIG. 9, the medium to long term plan unit 303 includes a route search unit 331, a map acquisition unit 332, a positioning accuracy map storage unit 333, a communication resource map storage unit 334, a planned vehicle speed setting unit 335, an environmental condition acquisition unit 336, a map selection unit 337, a request identification unit 338, a selectable map generation unit 339, and a recommended route determination unit 340 as functional blocks. The medium to long term plan unit 303 corresponds to a travel plan generation device.

When the departure point, the destination, and the departure time are set, the route search unit 331 searches for a candidate of the route (hereinafter referred to as a candidate route) for traveling from the departure point to the destination, and set the route search range including the candidate route. For example, the route search unit 331 searches for multiple candidate routes according to predetermined search conditions such as time priority and distance priority, and set the route search range including the multiple candidate routes. A starting point (that is, the departure point) of the candidate route may be the current vehicle position determined by the ADAS locator 31 of the subject vehicle. Alternatively, the starting point of the candidate route may be a point input through the operation device 361 as the departure point based on the setting information output from the HCU 360. An end point (that is, the destination) of the candidate route may be a point input through the operation device 361 as the destination based on the setting information output from the HCU 360. As for the departure point and the destination, those input in advance via a terminal or the like outside the subject vehicle may be set as the departure point and the destination. The departure time may be the time received by the operation device 361 or the like. Alternatively, the departure time may be the current time.

The map acquisition unit 332 acquires the communication resource map and the positioning accuracy map received from the map distribution center 2 by the communication terminal 35. As an example, the map acquisition unit 332 causes the communication terminal 35 to transmit the request information requesting the positioning accuracy map, and acquires the positioning accuracy map distributed from the map distribution center 2 in response to the request information. The map acquisition unit 332 causes the communication terminal 35 to transmit the request information requesting the communication resource map, and acquires the communication resource map distributed from the map distribution center 2 in response to the request information. For example, the range identification information included in the request information may be provided by the mesh code of the map including the route search range set by the route search unit 331. That is, the map acquisition unit 332 acquires the communication resource map and the positioning accuracy map corresponding to the route search range.

The positioning accuracy map storage unit 333 temporarily stores the positioning accuracy map acquired by the map acquisition unit 332. The positioning accuracy map temporarily stored in the positioning accuracy map storage unit 333 is a positioning accuracy map group for each condition such as the time zone, the weather information, the traveling direction, and the satellite arrangement. When the map acquisition unit 332 acquires a positioning accuracy map covering multiple regions from the map distribution center 2, the positioning accuracy map is also a positioning accuracy map group for each region. The positioning accuracy map temporarily stored in the positioning accuracy map storage unit 333 may be deleted after a certain period of time has elapsed, or may be deleted when the subject vehicle reaches the destination.

The configuration in which the positioning accuracy map acquired by the map acquisition unit 332 is temporarily stored in the positioning accuracy map storage unit 333 is shown, but the configuration is not necessarily limited thereto.

For example, the positioning accuracy map storage unit 333 may store a part of the positioning accuracy map stored in the positioning accuracy map storage unit 23 of the map distribution center 2 in advance. In this case, the positioning accuracy map stored in advance in the positioning accuracy map storage unit 333 may be a positioning accuracy map for a region where the subject vehicle is expected to be frequently used and its suburbs. Further, in this case, when the positioning accuracy map acquired by the map acquisition unit 332 is a new positioning accuracy map for the same condition such as a region, weather information, or the like, the old positioning accuracy map having the same condition is updated. When the positioning accuracy map has a different condition, the positioning accuracy map storage unit 333 newly stores the positioning accuracy map.

The communication resource map storage unit 334 temporarily stores the communication resource map acquired by the map acquisition unit 332. The communication resource map temporarily stored in the communication resource map storage unit 334 is a group of positioning accuracy maps for each time zone. When the map acquisition unit 332 acquires a communication resource map covering multiple regions from the map distribution center 2, the communication resource map is also a group of communication resource maps for each region. The communication resource map temporarily stored in the communication resource map storage unit 334 may be deleted after a certain period of time has elapsed, or may be deleted when the subject vehicle reaches the destination.

The configuration in which the communication resource map acquired by the map acquisition unit 332 is temporarily stored in the communication resource map storage unit 334 is shown, but the configuration is not necessarily limited thereto. For example, the communication resource map storage unit 334 may store a part of the communication resource map stored in the communication resource map storage unit 22 of the map distribution center 2 in advance. In this case, the communication resource map stored in advance in the communication resource map storage unit 334 may be a communication resource map for a region where the subject vehicle is expected to be frequently used and its suburbs. Further, in this case, when the communication resource map acquired by the map acquisition unit 332 is a new communication resource map for the same condition such as a region, a time zone, or the like, the old communication resource map having the same condition is updated. When the communication resource map has a different condition, the communication resource map storage unit 334 newly stores the communication resource map.

The planned vehicle speed setting unit 335 tentatively sets the planned vehicle speed for each region of the route search range. The region may be a region in which the units are aligned with the communication resource map and the positioning accuracy map. For example, the planned vehicle speed setting unit 335 may set the speed limit value of the link corresponding to each region as the planned vehicle speed for each region based on the speed limit value for each link included in the map data. Further, the planned vehicle speed setting unit 335 sets the planned vehicle speed for each link of the recommended route determined by the recommended route determination unit 340.

The environmental condition acquisition unit 336 acquires an environmental condition for the route search range set by the route search unit 331. The environmental condition acquisition unit 336 requests the map distribution center 2 for the environmental condition regarding the route search range from the communication terminal 35, and acquires the environmental condition such as weather information or satellite arrangement for the route search range distributed from the map distribution center 2 via the communication terminal 35. As described above, the environmental condition for the route search range distributed from the map distribution center 2 is preferably information for each time zone over a certain period or more in the future. Further, the environmental condition acquisition unit 336 may acquire the time zone of the environmental condition by identifying the time zone from the current time. The environmental condition acquisition unit 336 may acquire the traveling direction from the traveling direction of the candidate route searched by the route search unit 331.

The map selection unit 337 selects a positioning accuracy map according to the environmental condition acquired by the environmental condition acquisition unit 336 from the group of positioning accuracy maps corresponding to the route search range stored in the positioning accuracy map storage unit 333. As an example, among the positioning accuracy maps for each environmental condition stored in the positioning accuracy map storage unit 333, the map selection unit 337 may select the positioning accuracy map corresponding to the environmental condition acquired by the environmental condition acquisition unit 336. When the route search range covers the positioning accuracy maps of multiple regions, the map selection unit 337 selects the positioning accuracy map for the time zone different for each region by estimating the time zone in which the subject vehicle travels for each region based on the departure time of the departure point, the candidate route searched by the route search unit 331, and each region of the route search range set by the planned vehicle speed setting unit 335.

Further, the map selection unit 337 selects a communication resource map according to the departure time of the departure point from the group of communication resource maps corresponding to the route search range stored in the communication resource map storage unit 334. As an example, among the communication resource maps for each time zone stored in the communication resource map storage unit 334, the map selection unit 337 may select the communication resource map for the time zone including the departure time of the departure point. When the route search range covers the communication resource maps of multiple regions, the map selection unit 337 selects the communication resource map for the time zone different for each region by estimating the time zone in which the subject vehicle travels for each region based on the departure time of the departure point, the candidate route searched by the route search unit 331, and each region of the route search range set by the planned vehicle speed setting unit 335.

The request identification unit 338 identifies the amount of communication resources (hereinafter, the required communication resource amount) required for an application including at least driving support in the subject vehicle. In other words, the request identification unit 338 identifies the amount of communication resources required when driving support is performed by positioning usage information acquired using the communication resource. In an example of the present embodiment, the request identification unit 338 identifies the required communication resource amount that enables automatic driving by the positioning usage information acquired using the communication resources, even when the positioning accuracy of the position of the subject vehicle by the autonomous sensor is less than the threshold value described later.

The request identification unit 338 identifies the required communication resource amount according to the application executed by the subject vehicle. For example, as the number of applications to be executed increases, the request identification unit 338 identifies the required communication resource amount by being increased, or identifies the required communication resource amount for each application and increases the communication resource amount for which the application has larger required communication resource amount. With this configuration, the request identification unit 338 can identify the required communication resource amount with a high precision. Examples of the types of applications include entertainment-related applications and the like, in addition to driving support-related applications. The request identification unit 338 may identify a uniform value for each automatic driving level realized by the application of the driving support system. Alternatively, the request identification unit 338 may identify the required communication resource amount by being subdivided for each region. As an example, in a region, for example, having an intersection where the amount of information required for driving support is large, the required communication resource amount may be increased.

Further, the request identification unit 338 identifies a smaller required communication resource amount as the planned vehicle speed set by the planned vehicle speed setting unit 335 decreases. This is because less information is required per hour for driving support with the vehicle speed lowered. With this configuration, the request identification unit 338 can identify the required communication resource amount with a high precision.

The selectable map generation unit 339 extracts a point where a value of the positioning accuracy in the positioning accuracy map selected by the map selection unit 337 is equal to or higher than the threshold value, that is, a region corresponding to the point (hereinafter, a positioning accuracy satisfaction region). The threshold value referred to here may be a value of a positioning accuracy capable of providing driving support by the autonomous sensor of the subject vehicle, and may be a value corresponding to the target driving support. In the example of the present embodiment, the positioning accuracy may be such that automatic driving at the automatic driving level “4” is possible with the autonomous sensor. In addition, the selectable map generation unit 339 extracts a point where the communication resource amount in the communication resource map selected by the map selection unit 337 satisfies the required communication resource amount identified by the request identification unit 338, that is, the region corresponding to the point (hereinafter, a communication resource amount satisfied region). The selectable map generation unit 339 generates a selectable map showing regions which are interpolated with the extraction positioning accuracy satisfaction region and the communication resource amount satisfied region.

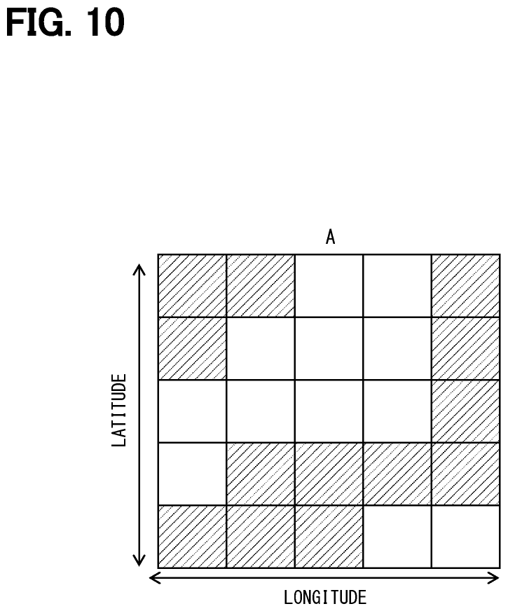

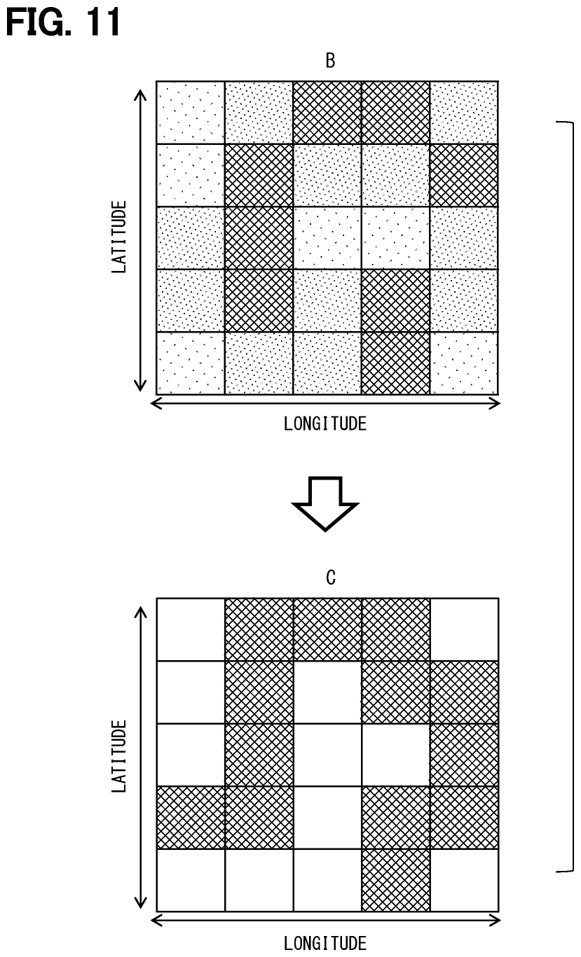

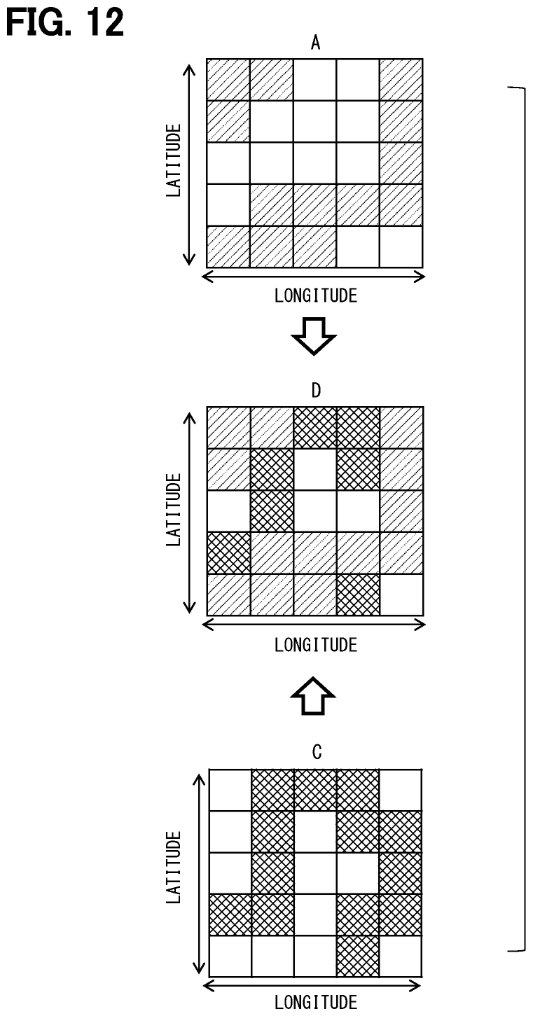

Here, an example of generating a selectable map will be described with reference to FIGS. 10 to 12. FIG. 10 is a schematic diagram for explaining an example of the positioning accuracy satisfaction region. FIG. 11 is a schematic diagram for explaining an example of extracting a communication resource amount satisfaction region from the communication resource amount map selected by the map selection unit 337. FIG. 12 is a schematic diagram for explaining an example of generating a selectable map from the positioning accuracy satisfaction region and the communication resource amount satisfaction region.

First, the dark region shown in FIG. 10 is a visualization of the positioning accuracy satisfaction region. Subsequently, B in FIG. 11 visualizes the communication resource map selected by the map selection unit 337, and the dark region shown in C visualizes the communication resource amount satisfaction region extracted from the communication resource map of B. The regions with different densities in the communication resource map of B indicate regions with different communication resource amounts. Even when the regions have the same density of the communication resource map of B, the regions are divided into the region that corresponds to the communication resource amount satisfaction region and the region that does not correspond to the communication resource amount satisfaction region. This is because the required communication resource amounts are different from each region. Then, the dark region shown in D of FIG. 12 is a visualization of the selectable map generated from the positioning accuracy satisfaction region of A and the communication resource amount satisfaction region of C.

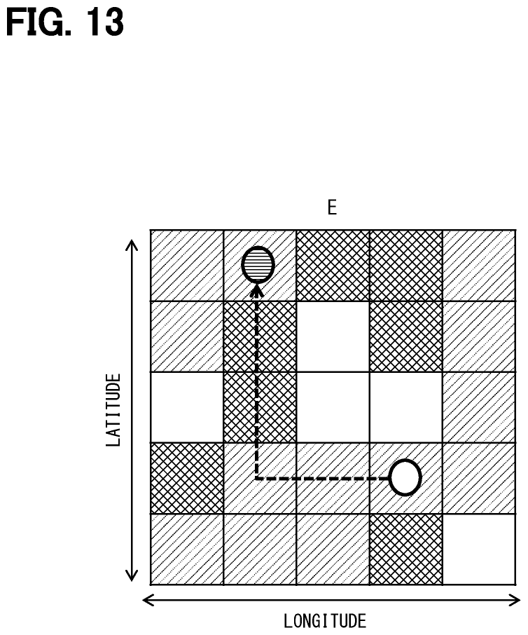

The recommended route determination unit 340 determines a recommended route for the subject vehicle and generates the recommended route. The recommended route determination unit 340 searches for a recommended route from the candidate route searched by the route search unit 331 and the selectable map generated by the selectable map generation unit 339. The recommended route determination unit 340 searches for a route capable of being generated by at least one of the positioning accuracy satisfaction region and the communication resource amount satisfaction region in the selectable map among the candidate routes searched by the route search unit 331. When a route capable of being generated in at least one of the positioning accuracy satisfaction region and the communication resource amount satisfaction region in the selectable map (see the dashed arrow in FIG. 13) can be searched, the recommended route determination unit 340 determines this route as the recommended route and generates the recommended route. FIG. 13 is a schematic diagram for explaining an example of searching for a recommended route from a candidate route and a selectable map. E in FIG. 13 shows the same selectable map as D in FIG. 12. The white circle indicates the departure point, the black circle indicates the destination, and the arrow indicates the recommended route.

On the other hand, when a route capable of being generated in at least one of the positioning accuracy satisfaction region and the communication resource amount satisfaction region in the selectable map cannot be obtained by the search, the planned vehicle speed setting unit 335 sets the planned vehicle speed lower in the region that corresponds to neither the positioning accuracy satisfaction region nor the communication resource amount satisfaction region. The region corresponding to the candidate route may be a route search range, or may be the region that overlaps the candidate route of the communication resource map and the positioning accuracy map. The case where a route is incapable of being acquired in at least one of the positioning accuracy satisfaction region and the communication resource amount satisfaction region in the selectable map can be rephrased as the case where the point satisfying the required communication resource amount is insufficient. As an example, the tentatively set planned vehicle speed may be changed to be lowered by a predetermined value such as 5 km/h or 10 km/h.

After that, the request identification unit 338 identifies the required communication resource amount again according to the change of the planned vehicle speed. In response to the re-identification of the required communication resource amount, the selectable map generation unit 339 extracts the communication resource amount satisfaction region and regenerates the selectable map again. Then, the recommended route determination unit 340 searches for the recommended route again using the regenerated selectable map. When the recommended route determination unit 340 can search for the route capable of being generated by at least one of the positioning accuracy satisfaction region and the communication resource amount satisfaction region in the selectable map, the recommended route determination unit 340 determines the route as the recommended route and generates the recommended route. On the other hand, when the recommended route determination unit 340 cannot obtain a route generated by at least one of the positioning accuracy satisfaction region and the communication resource amount satisfaction region in the selectable map, the above processing is repeated.

In the selectable map, the region corresponding to the positioning accuracy satisfaction region is the region where the vehicle can automatically travel with the autonomous sensor, and the region corresponding to the communication resource amount satisfaction region is the region where the vehicle can automatically travel with the positioning usage information acquired by the subject vehicle using the communication resource. Therefore, when the recommended route determination unit 340 determines, as the recommended route, the route capable of being generated from at least one of the positioning accuracy satisfaction region and the communication resource amount satisfaction region in the selectable map, the recommended route that more reliably guarantees the continuation of automatic can be generated.

The recommended route determined by the recommended route determination unit 340 and the planned vehicle speed in this recommended route set by the planned vehicle speed setting unit 335 are output to the automatic driving function unit 304, and the automatic driving function unit 304 causes the subject vehicle to perform automatic driving according to the recommended route and the planned vehicle speed. The recommended route determination unit 340 and the planned vehicle speed setting unit 335 correspond to a travel plan generation unit. Further, the recommended route determined by the recommended route determination unit 340 is output to the HCU 360, and the HCU 360 causes the display device 362 to display the recommended route.

(Recommended Route Determination Related Processing in the Medium to Long Term Plan Unit 303)

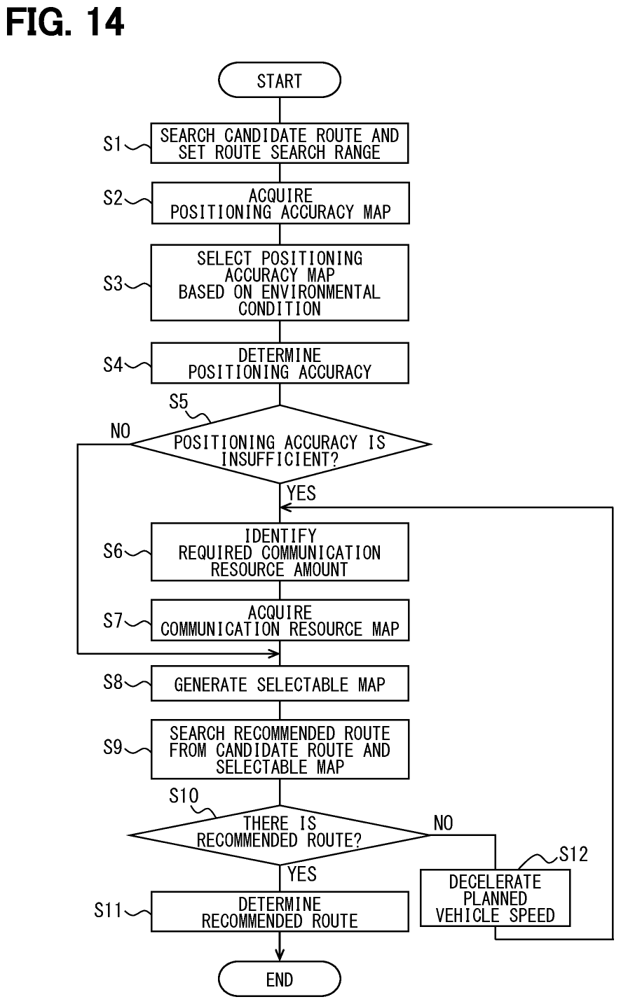

Subsequently, an example of the flow of the processing related to the determination of the recommended route in the medium to long term plan unit 303 (hereinafter, the recommended route determination related processing) will be described with reference to the flowchart of FIG. 14. In the flowchart of FIG. 14, the processing may start when the departure point, the destination, and the departure time are set.

In S1, the route search unit 331 searches for the candidate route when the subject vehicle travels from the departure point to the destination based on the set departure point, destination, and departure time, and sets the route search range including the candidate route. In S2, the communication terminal 35 transmits, to the map distribution center 2, the request information of the positioning accuracy map including the route search range set in S1 as the range identification information, and the map acquisition unit 332 acquires the positioning accuracy map distributed from the map distribution center 2 according to the request information. The positioning accuracy map storage unit 333 temporarily stores the positioning accuracy map acquired by the map acquisition unit 332.

In S3, the map selection unit 337 selects the positioning accuracy map according to the environmental condition acquired by the environmental condition acquisition unit 336 from the positioning accuracy map group for each environmental condition stored in the positioning accuracy map storage unit 333. In S4, the selectable map generation unit 339 extracts the positioning accuracy satisfaction region in which the positioning accuracy in the positioning accuracy map selected in S3 is equal to or greater than the threshold value. The recommended route determination unit 340 determines whether the positioning accuracy in the route search range is sufficient by determining each of the entire route search range can be generated by the positioning accuracy satisfaction region. When the entire route search range cannot be generated by the positioning accuracy satisfaction region, the recommended route determination unit 340 determines that the positioning accuracy in the route search range is insufficient. When the entire route search range can be generated by the positioning accuracy satisfaction region, the recommended route determination unit 340 determines that the positioning accuracy in the route search range is sufficient.

In S5, when it is determined in S4 that the positioning accuracy is insufficient (YES in S5), the processing proceeds to S6. On the other hand, when it is determined in S4 that the positioning accuracy is sufficient (NO in S5), the processing proceeds to S8.

In S6, the request identification unit 338 identifies the required communication resource amount according to the application executed by the subject vehicle and the planned vehicle speed set by the planned vehicle speed setting unit 335. In S7, the communication terminal 35 transmits, to the map distribution center 2, the request information of the communication resource map including the route search range set in S1 as the range identification information, and the map acquisition unit 332 acquires the communication resource map distributed from the map distribution center 2 according to the request information. The communication resource map storage unit 334 temporarily stores the communication resource map acquired by the map acquisition unit 332. Further, the map selection unit 337 selects the communication resource map according to the departure time of the departure point from the communication resource map group for each time zone stored in the communication resource map storage unit 334. The processes of S6 and S7 may be performed in parallel, or may be performed by changing the order.

In S8, the selectable map generation unit 339 extracts the communication resource amount satisfaction region that satisfies the required communication resource amount identified in S6 in the communication resource map selected in S7. The selectable map generation unit 339 generates the selectable map that shows the regions interpolated with the communication resource amount satisfaction region and the extraction positioning accuracy satisfaction region extracted in S4. When it is determined in S5 that the positioning accuracy is sufficient, the positioning accuracy satisfaction region is set as the selectable map.

In S9, the recommended route determination unit 340 searches for the recommended route capable of being generated by at least one of the positioning accuracy satisfaction region and the communication resource amount satisfaction region in the selectable map among the candidate routes from the candidate routes searched in S1 and selectable map generated in S8. In S10, when the recommended route can be obtained in S9, that is, when there is the recommended route (YES in S10), the processing proceeds to S11. On the other hand, when the recommended route cannot be obtained in S9, that is, when there is no recommended route (NO in S10), the processing proceeds to S12.

In S11, the recommended route determination unit 340 determines the recommended route searched in S9 as the recommended route, generates the recommended route, and terminates the recommended route determination related processing.

In S12, the planned vehicle speed setting unit 335 sets the planned vehicle speed lower in the region that corresponds to neither the positioning accuracy satisfaction region nor the communication resource amount satisfaction region in the region corresponding to the candidate route searched in S1, and then the processing returns to S6. After that, in the process of S6, the request identification unit 338 identifies the required communication resource amount again according to the change of lowering the planned vehicle speed, and the processes are repeated until the recommended route is found in S10.

In the example of FIG. 14, it is determined in S4 whether the positioning accuracy is insufficient. When the positioning accuracy is sufficient, the process of identifying the required communication resource amount in S6 and the process of acquiring the communication resource map in S7 are omitted. Therefore, there may be a route ensured that the value of the positioning accuracy of the autonomous sensor is equal to or more than the threshold value over the route. In this case, the communication resource is not necessary for the driving support. Thus, unnecessary processes of S6 and S7 are omitted in order to reduce processing load of the medium to long term plan unit 303. The flow is not limited to the example of FIG. 14. Alternatively, instead of the processes of S4, S5, and S7, the positioning accuracy map and the communication resource map according to the request information are acquired in S3, the positioning accuracy satisfaction region and the communication resource satisfaction region are generated, and then the process shifts to S8.

In the example of FIG. 14, when the medium to long term plan unit 303 determines the recommended route, the processing is terminated. The configuration is not limited thereto. For example, the map acquisition unit 332 of the medium to long term plan unit 303 may sequentially acquire the communication resource map or the positioning accuracy map, and the recommended route determination unit 340 may again determine a recommended route other than the recommended route that has been determined using the sequentially acquired communication resource map or positioning accuracy map. The configuration can determine more suitable recommended route each time according to the traveling situation of the recommended route. When this configuration is adopted, for example, the recommended route determination related processing may be terminated when the subject vehicle arrives at the destination.

(Summary of First Embodiment)

According to the configuration of the first embodiment, even in a point having the communication resource amount, in the communication resource map, which does not satisfy the required communication resource amount, when the point has the value of the positioning accuracy in the positioning accuracy map equal to or greater than the threshold value, the point can be the candidate for the recommended route and the traveling plan including the recommended route can be generated. Since it is not necessary to search for a recommended route that secures the required communication resource amount over the entire route, it is possible to suppress waste in generating a travel plan. Even in a point having the value of the positioning accuracy in the positioning accuracy map less than the threshold value, a point that satisfies the required communication resource amount can be a candidate for the recommended route and the traveling plan including the recommended route can be generated. Therefore, the configuration can generate a recommended route in which the driving support vehicle can reliably receive the driving support by the positioning usage information acquired by using the communication resource. As a result, the configuration can suppress waste in generating a travel plan for the driving support vehicle that uses the information acquired using the communication resource for the positioning of the subject vehicle.

Further, the configuration of the first embodiment can identify the required communication resource amount, with a high precision, according to the application executed in the subject vehicle and the planned vehicle speed set by the planned vehicle speed setting unit 335. Thus, it is possible to generate, with a high precision, the recommended route capable of receiving more reliable driving assistance.

Further, according to the configuration of the first embodiment, the positioning accuracy map is provided for each environmental condition, and the positioning accuracy map is used for generating the recommended route according to the environmental condition. Therefore, it is possible to generate, with a high precision, the recommended route capable of receiving more reliable driving assistance by identifying the positioning accuracy map according to the environmental condition with a high precision.

In addition, according to the configuration of the first embodiment, when the route generated by at least one of the positioning accuracy satisfaction region and the communication resource amount satisfaction region in the selectable map is not acquired, the planned vehicle speed setting unit 335 decreases the planned vehicle speed and the required communication resource amount is reduced. Therefore, it is possible to suppress a case where a recommended route capable of receiving the driving support more reliably cannot be generated, and suppress a case where a recommended route that is unnecessarily detoured is generated.

(Second Embodiment) In the first embodiment, the environmental condition for the route search range is distributed from the map distribution center 2 to the vehicle-side unit 3, and the environmental condition distributed from the map distribution center 2 is acquired by the environmental condition acquisition unit 336 of the medium to long term plan unit 303. The configuration is not necessarily limited thereto. For example, the map distribution center 2 may not distribute the environmental condition for the route search range. In this case, the environmental condition acquisition unit 336 may acquire the environmental condition from a center other than the map distribution center 2 by wide area communication, acquire the environmental condition acquired by the surrounding vehicles by vehicle-to-vehicle communication, or acquire the environmental condition from a sensing result of the autonomous sensor of the subject vehicle. For example, the weather information may be acquired by recognizing an image captured by the peripheral monitor camera.

Alternatively, when the map distribution center 2 receives the request information of the positioning accuracy map from the vehicle-side unit 3, the map distribution center 2 may distribute the positioning accuracy map by being narrowed down according to the environmental condition. As the environmental condition, the weather information held by the map distribution center 2 and the environmental condition other than the satellite arrangement may be identified by the map distribution center 2 as will be described below. For example, the departure time may be included in the request information so that the map distribution center 2 may identify the time zone from the departure time. The departure point and the destination may be included in the request information so that the map distribution center 2 may identify the traveling direction from the departure point and the destination.

(Third Embodiment)

In the first embodiment, the request identification unit 338 identifies the required communication resource amount according to the application executed by the subject vehicle and the planned vehicle speed set by the planned vehicle speed setting unit 335. The configuration is not necessarily limited thereto. For example, the request identification unit 338 may identify the required communication resource amount according to one of the application executed by the subject vehicle and the planned vehicle speed set by the planned vehicle speed setting unit 335. Alternatively, the medium to long term plan unit 303 may hold in advance a fixed value such as the maximum communication resource amount estimated to be required for the subject vehicle, and request identification unit 338 may identify the fixed value as the required communication resource amount.

(Fourth Embodiment)

In the first embodiment, the configuration is applied to a vehicle that automatically drives at an automatic driving level of “4” or higher as the driving support. The configuration is not necessarily limited thereto. The configuration may be applied to a vehicle capable of supporting the drive by the positioning usage information acquired by using communication resource. The vehicle may automatically drive at an automatic driving levels “1” to “3” as the driving support. For example, when the configuration is applied to a vehicle that automatically drives at an automatic driving level of “1”, the position result that identifies the subject vehicle may be used for driving support, such as acceleration/deceleration control for maintaining the inter-vehicle distance, deceleration control for reducing damage of collision, or steering control in order not to deviate from the lane.

Further, when the configuration is applied to a vehicle of which the driver is obliged to monitor the drive, such as the vehicle having automatic driving levels “1” and “2”, the process of S12 in FIG. 14 may be omitted. This is because when the driver is obliged to monitor the driving support, the requirement for positioning accuracy and required communication resource amount is low. Thus, a case where a route generated by at least one of the positioning accuracy satisfaction region and the communication resource amount satisfaction region in the selectable map cannot be acquired is unlikely to occur.

(Fifth Embodiment)

In the first embodiment, the positioning accuracy map is stored for each environmental condition. The configuration is not necessarily limited thereto. For example, when the positioning accuracy map is not stored for each environmental condition, the medium to long term plan unit 303 may not include the environmental condition acquisition unit 336, and the map selection unit 337 may not perform the process of selecting the positioning accuracy map according to the environmental condition.

(Sixth Embodiment)

In the first embodiment, when the map acquisition unit 332 causes the communication terminal 35 to transmit the request information to the map distribution center 2, the communication resource map and the positioning accuracy map according to the request information are received from the map distribution center 2. The configuration is not necessarily limited thereto. For example, the map distribution center 2 may sequentially distribute, to the communication terminal 35 of the vehicle-side unit 3, the communication resource map and the positioning accuracy map for a region corresponding to a position of the subject vehicle regardless of whether or not the map distribution center 2 receives the request information.

(Seventh Embodiment)

In the above-described embodiments, the medium to long term plan unit 303 is provided in the automatic driving ECU 30. The configuration is not necessarily limited thereto. For example, an in-vehicle device such as an electronic control device or a navigation device other than the automatic driving ECU 30 may be provided with the medium to long term plan unit 303, or multiple devices may function as the medium to long term plan unit 303. Further, the function of the medium to long term plan unit 303 may be performed by a center outside the driving support vehicle, such as the map distribution center 2 that communicates with the driving support vehicle.

When the map distribution center 2 takes on the function of the medium to long term plan unit 303, various information necessary for determining the recommended route such as information on the departure point, destination, and departure time is acquired from the subject vehicle. The center-side control unit 24 may determine the recommended route, similarly to the medium to long term plan unit 303 of the first embodiment, using the acquired information, the communication resource map stored in the communication resource map storage unit 22, and the positioning accuracy map stored in the positioning accuracy map storage unit 23. Then, the map distribution center 2 may distribute the determined recommended route from the wide area communication unit 21 to the subject vehicle. Therefore, the map distribution center 2 also corresponds to the travel plan generation unit. In this case, the center-side control unit 24 includes functional blocks similar to the route search unit 331, the planned vehicle speed setting unit 335, the environmental condition acquisition unit 336, the map selection unit 337, the request identification unit 338, the selectable map generation unit 339, and the recommended route determination unit 340.

A flowchart or a process of the flowchart described in the present disclosure includes multiple parts (or steps), and each part is expressed, for example, as S1. Furthermore, each part may be divided into multiple sub-parts, while the multiple parts may be combined into one part. Each of these sections may also be referred to as a circuit, a device, a module, or means.

Each of the plurality of sections or some of the sections combined to each other can be embodied as (i) a software section combined with a hardware unit (e.g., a computer) or (ii) a hardware section (e.g., an integrated circuit or a wiring logic circuit) including or excluding a function of a relevant device. The hardware section may still alternatively be installed in a microcomputer.

Note that the present disclosure is not limited to the embodiments described above and can variously be modified within the scope of claims. An embodiment obtained by appropriately combining the technical means disclosed in the different embodiments is also included in the technical scope of the present disclosure.

What is claimed is:

1. A travel plan generation device comprising a processor configured to:
generate a travel plan including a recommended route for a travel of a driving support vehicle, the drive support vehicle being a vehicle configured to (i) perform a driving support for the vehicle by performing a positioning to identify a position of the vehicle using an autonomous sensor attached to the vehicle and (ii) perform the driving support based on information obtained by a communication resource;
store a communication resource map indicating a correspondence relationship between a point and a communication resource amount that is an amount of the communication resource estimated to be available for communication at the point;
store a positioning accuracy map indicating a correspondence relationship between a point and a positioning accuracy estimated when the autonomous sensor performs the positioning of the vehicle at the point; and
identify a required communication resource amount that is a communication resource amount required for executing an application including at least the driving support for the driving support vehicle, wherein
the processor selects, as a candidate for the recommended route, a point having a value of the positioning accuracy in the positioning accuracy map equal to or greater than a threshold value even when the communication resource amount in the communication resource map does not satisfy the required communication resource amount at the point, and
the processor selects, as the candidate for the recommended route, a point having the communication resource amount in the communication resource map which satisfies the required communication resource amount even when the value of the positioning accuracy in the positioning accuracy map is less than the threshold value at the point.

2. The travel plan generation device according to claim 1, wherein
the processor identifies the required communication resource amount according to the application executed by the driving support vehicle.

3. The travel plan generation device according to claim 1, wherein
the driving support vehicle performs, as the driving support, at least automatic driving that automatically controls acceleration, braking, and steering, and
the processor decreases the required communication resource amount with a decrease of a planned vehicle speed that is planned in the automatic driving.

4. The travel plan generation device according to claim 3, wherein
the processor determines, as the travel plan, the planned vehicle speed for the driving support vehicle to perform the automatic driving on the recommended route, and
the processor decreases the planned vehicle speed when a point having the communication resource amount that satisfies the required communication resource amount is insufficient for generating the recommended route.

5. The travel plan generation device according to claim 1, wherein
a plurality of positioning accuracy maps are provided for each environmental condition indicating a condition of an environment,
the positioning accuracy map stores the plurality of positioning accuracy maps, and
the processor is further configured to acquire the environmental condition, and select one of the plurality of positioning accuracy maps according to the environmental condition.

6. The travel plan generation device according to claim 5, wherein
the processor stores the plurality of positioning accuracy maps for each environmental condition including at least one of an arrangement of positioning satellite, weather information, a traveling direction, and a time zone, and
the processor acquires, as the environmental condition, at least one of the arrangement of positioning satellite, the weather information, the traveling direction, and the time zone.

7. The travel plan generation device according to claim 1, wherein
the processor is provided in the driving support vehicle,
the processor is further configured to acquire the communication resource map and the positioning accuracy map distributed from a center provided outside the travel plan generation device, and
the communication resource map stored in the communication resource map storage unit and the positioning accuracy map stored in the processor are respectively updated by the communication resource map and the positioning accuracy map distributed from the center.

8. A travel plan generation method comprising:
generating a travel plan including a recommended route for a travel of a driving support vehicle, the drive support vehicle being a vehicle configured to (i) perform a driving support for the vehicle by performing a positioning to identify a position of the vehicle using an autonomous sensor attached to the vehicle and (ii) perform the driving support based on information obtained by a communication resource;
storing a communication resource map indicating a correspondence relationship between a point and a communication resource amount that is an amount of the communication resource estimated to be available for communication at the point;
storing a positioning accuracy map indicating a correspondence relationship between a point and a positioning accuracy estimated when the autonomous sensor performs the positioning of the vehicle at the point; and
identifying a required communication resource amount that is a communication resource amount required for executing an application including at least the driving support for the driving support vehicle, wherein
the generating of the travel plan includes selecting, as a candidate for the recommended route, a point having a value of the positioning accuracy in the positioning accuracy map equal to or greater than a threshold value even when the communication resource amount in the communication resource map does not satisfy the required communication resource amount at the point, and
the generating of the travel plan includes selecting, as the candidate for the recommended route, a point having the communication resource amount in the communication resource map which satisfies the required communication resource amount even when the value of the positioning accuracy in the positioning accuracy map is less than the threshold value at the point.

9. A non-transitory tangible computer readable storage medium comprising instructions executed by a processor of a travel plan generation device, the instructions comprising:
generating a travel plan including a recommended route for a travel of a driving support vehicle, the drive support vehicle being a vehicle configured to (i) perform a driving support for the vehicle by performing a positioning to identify a position of the vehicle using an autonomous sensor attached to the vehicle and (ii) perform the driving support based on information obtained by a communication resource;
storing a communication resource map indicating a correspondence relationship between a point and a communication resource amount that is an amount of the communication resource estimated to be available for communication at the point;
storing a positioning accuracy map indicating a correspondence relationship between a point and a positioning accuracy estimated when the autonomous sensor performs the positioning of the vehicle at the point; and
identifying a required communication resource amount that is a communication resource amount required for executing an application including at least the driving support for the driving support vehicle, wherein
the generating of the travel plan includes selecting, as a candidate for the recommended route, a point having a value of the positioning accuracy in the positioning accuracy map equal to or greater than a threshold value even when the communication resource amount in the communication resource map does not satisfy the required communication resource amount at the point, and
the generating of the travel plan includes selecting, as the candidate for the recommended route, a point having the communication resource amount in the communication resource map which satisfies the required communication resource amount even when the value of the positioning accuracy in the positioning accuracy map is less than the threshold value at the point.
